(19) United States
(12) Patent Application Publication
(10) Pub. No.: US 2013/0082064 A1
(43) Pub. Date: Apr. 4, 2013

(54) Polyoxymethylene Compositions For Producing Containment Devices

(71) Applicant: TICONA LLC, Florence, KY (US)

(72) Inventors: Lowell Larson, Independence, KY (US); Ursula Ziegler, Mainz-Kostheim (DE); Malvika Bihari, Florence, KY (US)

(73) Assignee: TICONA LLC, Florence, KY (US)

(21) Appl. No.: 13/631,072

(22) Filed: Sep. 28, 2012

Related U.S. Application Data
(60) Provisional application No. 61/460,779, filed on Sep. 29, 2011.

(51) Int. Cl. B65D 1/40; B29C 49/00; B65D 6/32; B32B 37/16

(52) U.S. Cl. 220/600; 156/242; 264/500

(57) ABSTRACT

Polyoxymethylene polymer compositions are disclosed that contain an impact modifier. In accordance with the present disclosure, the impact modifier is attached to the polyoxymethylene polymer and comprises a thermoplastic elastomer containing carbonate groups, such as polycarbonate groups. In one embodiment, a coupling agent bonds the impact modifier to the polyoxymethylene polymer. Incorporation of an impact modifier containing carbonate groups has been found to produce articles having good impact resistance properties while also preserving the permeability of the material. The polymer composition is well suited to producing containment devices, especially fuel tanks.

### RELATED APPLICATIONS

This application claims filing benefit of U.S. Provisional Patent Application Ser. No. 61/460,779, filed on Sep. 29, 2011, and which is incorporated herein by reference in its entirety.

### BACKGROUND

Fuel tanks for use in vehicles or other mobile devices should generally possess various characteristics and properties. For instance, the fuel tanks should be capable of holding a fuel without significant amounts of fuel vapor escaping. The tanks should also be chemically resistant to the fuel that is contained in the tanks. The fuel tanks should also have good impact resistance properties. In the past, conventional fuel tanks were generally made from a metal.

In the relatively recent past, those skilled in the art have attempted to design fuel tanks made from polymers. For instance, many small fuel tanks, such as those used by small off-road vehicles and devices, are currently made from high density polyethylene. High density polyethylene has good impact strength resistance properties. The above polymer, however, has a tendency to release fuel vapors over time. Consequently, fuel tanks made from high density polyethylene are typically fluorinated which not only adds significant cost to the product but is also shown to produce inconsistent results. Thus, those skilled in the art have been seeking to produce polymer fuel tanks from other types of polymers.

In this regard, those skilled in the art have proposed using polyester polymers to produce fuel tanks, particularly small fuel tanks. For instance, in U.S. Patent Application Publication No. 2006/0175325, which is incorporated herein by reference, an impact modified polyester is disclosed which comprises a polyester combined with an olefin-vinyl alcohol component and an impact modifier component.

Another type of polymer that has good permeability resistance properties are polyoxymethylene polymers. Although standard polyoxymethylene polymers have good permeability resistance, the polymers tend to have insufficient impact strength for fuel tank applications due to the high crystallinity of the material. The impact strength of polyoxymethylene polymers can be improved by incorporating an impact modifier into the material. It is known, however, that incorporating an impact modifier into a polyoxymethylene polymer can significantly increase the permeability properties of the polymer. Thus, problems have been encountered in being able to develop a polymer material containing a polyoxymethylene polymer for use in producing fuel tanks.

In U.S. Patent Application Publication No. 2009/0220719, which is incorporated herein by reference, a low fuel-permeable thermoplastic vessel is described made from a polyoxymethylene polymer in combination with an impact modifier. The '719 application teaches using an “uncompatibilized” blend of a polyoxymethylene, a thermoplastic polyurethane, and a copolyester. The term “uncompatibilized” as used in the '719 application means that the compositions do not contain polymer compatibilizers.

Although the teachings of the '719 application have provided great advancements in the art, further improvements are still needed.

### SUMMARY

The present disclosure is generally directed to a polymer composition containing a polyoxymethylene polymer in combination with an impact modifier that comprises a thermoplastic elastomer containing polycarbonate units. As will be described in greater detail below, the polymer composition is particularly well suited for producing containment devices, such as fuel tanks. When producing articles, such as containment devices using the polymer composition, the impact modifier chemically attaches to the polyoxymethylene polymer. The polymer composition not only has very good impact strength resistance properties, but is also well suited to preventing fuel vapors and gases from escaping the containment device over time. In particular, the polymer composition can be formulated so as to reduce or prevent volatile organic compound (“VOC”) vapor emissions while still providing a fuel tank that is capable of not rupturing, even when subjected to relatively high impact forces at colder temperatures.

In this regard, in one embodiment, the present disclosure is directed to a containment device, such as a container, that includes an opening configured to receive a VOC, a compressed gas, and/or a fuel. The containment device may also include a discharge for feeding the fuel to a combustion engine or other similar device. The containment device defines a volume surrounded by a wall.

In accordance with the present disclosure, the wall is made from a polymer composition comprising a polyoxymethylene polymer. For example, the polyoxymethylene polymer may comprise a polyoxymethylene in which at least 50% of the terminal groups are hydroxyl groups. For instance, at least about 70% of the terminal groups can be hydroxyl groups, such as at least about 80% of the terminal groups can be hydroxyl groups, such as even greater than about 85% of the terminal groups can be hydroxyl groups. In addition, the polyoxymethylene polymer may contain little or no low molecular weight constituents having a molecular weight below 10,000 dalton. For instance, the polyoxymethylene polymer can contain low molecular weight constituents in an amount less than about 10% by weight, such as in an amount less than about 5% by weight, such as in an amount less than about 3% by weight, based on the total mass of polyoxymethylene.

In addition to a polyoxymethylene polymer, the composition further includes an impact modifier that is attached to the polyoxymethylene polymer. The impact modifier may comprise, for instance, a thermoplastic elastomer, such as a thermoplastic polyurethane elastomer. More particularly, the impact modifier comprises a thermoplastic elastomer that contains polycarbonate units. Using a thermoplastic elastomer containing polycarbonate units has been found to significantly reduce permeation through the walls of the containment device while still maintaining impact strength.

A coupling agent may be used to couple the impact modifier to the polyoxymethylene polymer. The coupling agent, for instance, may comprise an isocyanate. For example, in one embodiment, the coupling agent may comprise methylenediphenyl 4,4′-diisocyanate.

As described above, the polymer composition of the present disclosure has low permeability properties. For example, the permeation of the polymer composition can be less than about 5 g mm/m² day at 40° C. when tested according to SAE Test J2665. For instance, the permeation can be less than about 4 g mm/m² day, such as less than about 3 g mm/m² day, such as less than about 2.5 g mm/m² day, such as less than about 1.5 g mm/m² day. In one embodiment, for instance, the permeation may be from about 0.1 g mm/m² day to about 2.5 g mm/m² day, such as from about 0.1 g mm/m² day to about 1.5 g mm/m² day.

When tested with a 2 mm wall thickness, for instance, the permeation can be less than about 2.5 g/m² day, such as less than 2 g/m² day, such as even less than 1.5 g/m² day. When tested with a 3 mm wall thickness, the permeation can also be less than about 2.5 g/m² day, such as less than about 1.5 g/m² day. In one embodiment, for instance, a 3 mm wall thickness may have a permeation of from about 0.05 g/m² day to about 1 g/m² day.

Of particular advantage, the polymer composition can have the above permeation properties even when relatively large amounts of the thermoplastic elastomer is incorporated into the composition. For example, the polymer composition may contain the impact modifier in an amount from about 5% by weight to about 30% by weight. In one embodiment, the impact modifier can be present in the polymer composition in an amount from about 17% to about 25% by weight while still producing a composition that has a permeation of less than 3 g/m² day when tested at a thickness of 2 mm and at 40° C.

As described above, the impact modifier comprises a thermoplastic elastomer containing polycarbonate units. In one embodiment, for instance, the thermoplastic polyurethane elastomer may comprise a thermoplastic polyurethane elastomer. In one embodiment, the thermoplastic elastomer may contain polycarbonate units such that the impact modifier has a shore A hardness of from about 85 to about 95 according to ISO Test 868.

In addition to having excellent permeation properties, the polymer composition of the present disclosure can also display excellent impact strength. For instance, the polymer composition may have a Charpy notched impact strength of greater than about 7 kJ/m² when measured at −30° C. according to ISO Test 179/1eA. For example, the polymer composition may have a Charpy notched impact strength of greater than about 8 kJ/m². In one embodiment, the polymer composition may have a Charpy notched impact strength of from about 7 kJ/m² to about 15 kJ/m² when measured at −30° C.

As described above, the polyoxymethylene polymer contains relatively low amounts of low molecular weight constituents. In one embodiment, the polyoxymethylene polymer can be produced with relatively low amounts of low molecular weight constituents by using a heteropoly acid catalyst. The amount of polyoxymethylene polymer contained in the composition can generally be from about 50% to about 95% by weight, such as greater than about 65% by weight, such as greater than about 70% by weight. The impact modifier, on the other hand, can generally be present in an amount from about 5% by weight to about 30% by weight, such as from about 10% by weight to about 25% by weight. The coupling agent, on the other hand, can generally be present in an amount less than about 5% by weight, such as in an amount from about 0.2% to about 3% by weight.

Although the polymer composition is suitable for producing all types of containment devices for VOC's and compressed gases, in one embodiment, a fuel tank is constructed having a fuel capacity of up to about ten gallons. Of particular advantage, the fuel tank can be comprised of only a monolayer of the polymer composition. The container wall can generally have a thickness of from about 0.5 mm to about 10 mm, such as from about 1.5 mm to about 5 mm.

Any suitable molding process may be used to produce the containment device. For instance, in one embodiment, the containment device is blow molded. In an alternative embodiment, however, the containment device is injection molded. For instance, two different portions of the containment device may be injection molded and then later welded together.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a fuel tank made in accordance with the present disclosure; and

FIG. 2 is a cross sectional view of the fuel tank illustrated in FIG. 1.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polymer compositions containing a polyoxymethylene polymer that are particularly well suited to molding articles, such as containment devices. For example, in one embodiment, containment devices may be made in accordance with the present disclosure that are particularly well suited for use as fuel tanks or as tanks designed to hold VOC and compressed gases. As will be described in greater detail below, the polyoxymethylene polymer composition is formulated in a manner that produces molded articles with very good impact resistance properties in combination with very good permeability properties. In particular, the polymer composition is capable of producing molded articles that are relatively impermeable to gas vapors, such as fuel vapors and other volatile organic compounds, and impermeable to compressed gases, such as natural gas, propane, and other hydrocarbon gases.

In the past, various problems were encountered in producing fuel tanks from polyoxymethylene polymers. Although polyoxymethylene polymers have good natural permeability properties, the materials tend not to have acceptable impact strength when used in fuel tank applications due to the high crystallinity of the material. Increasing the impact strength with compatibilized impact modifiers, however, may adversely affect the permeability properties of the material.

The present disclosure is directed to overcoming the above problems. In particular, the present disclosure is directed to a polymer composition that contains a polyoxymethylene polymer in combination with an impact modifier that increases the impact strength of the polyoxymethylene polymer while maintaining the permeability properties of the material within acceptable limits. In this regard, the polymer composition contains an impact modifier that comprises a thermoplastic elastomer containing polycarbonate units. In one embodiment, the impact modifier is chemically attached to the polyoxymethylene polymer.

The polymer composition of the present disclosure can be used to produce many different types of articles. Due to the permeability properties of the polymer composition, the composition is particularly well suited to producing containment devices for holding liquids and gases. For example, the polymer composition may be used to produce fuel tanks. The fuel tanks can be made from a single blow-molded part or can be made from multiple parts welded together. The fuel tanks can have any suitable volumetric capacity depending upon the particular application. In one particular embodiment, the polymer composition may be used to produce fuel tanks for a category of engines referred to as small off-road engines. Such engines typically have a power rating of up to 25 horsepower and are used in various vehicles and mobile devices. For instance, small off-road engines are typically used in small utility equipment, lawn mowers, weed trimmers, chain saws, motorcycles, lawn tractors, blowers, and the like. Such fuel tanks typically have a fuel capacity of less than 20 gallons, such as less than 10 gallons, and particularly less than 5 gallons.

It should be understood, however, that other products and articles in addition to fuel tanks may be made in accordance with the present disclosure. In particular, any type of VOC or compressed gas containment device may be made in accordance with the present disclosure. In addition to tanks, for instance, a containment device may comprise a tube, a hose, or any other similar device. The containment device, for instance, may be designed to contact or contain hydrocarbon fluids, pesticides, herbacides, brake fluid, paint thinners, and various compressed hydrocarbon gases, such as natural gas, propane, and the like. When used as a fuel tank, the containment device may contact or contain any suitable hydrocarbon fluid, whether liquid or gas.

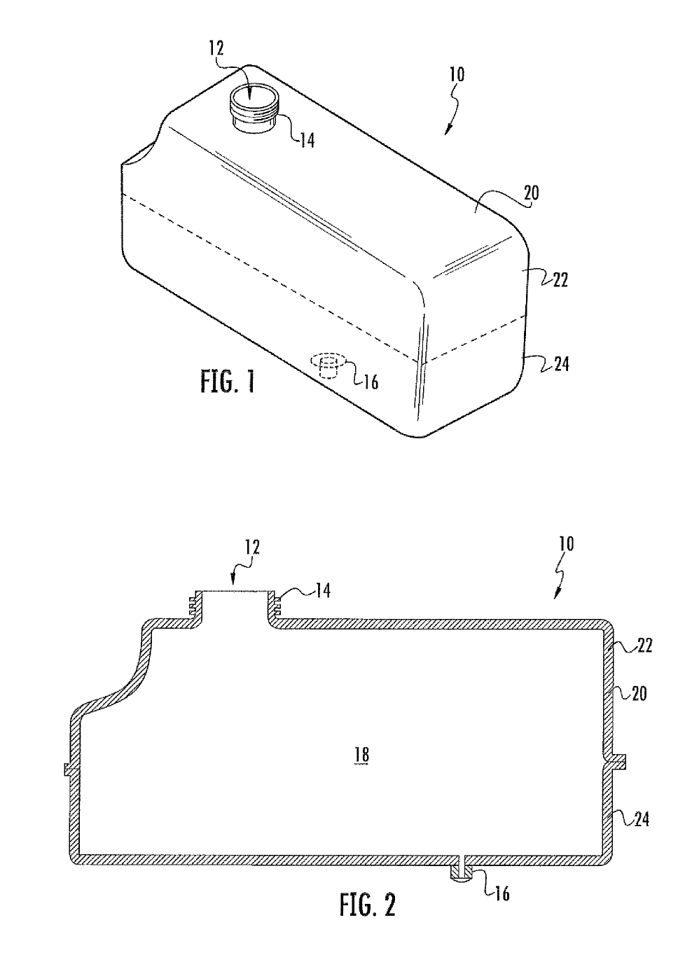

Referring to FIGS. 1 and 2, for instance, one embodiment of a fuel tank 10 that may be made in accordance with the present disclosure is shown. The fuel tank 10 includes an opening or inlet 12 for receiving a fuel. The opening 12 can be defined by a threaded fixture 14. The threaded fixture 14 is adapted for receiving a fuel and for receiving a cap (not shown). A cap can be placed over the threaded fixture 14, for instance, in order to prevent fuel and vapors from leaving the fuel tank 10.

The fuel tank 10 further includes at least one outlet 16 for feeding a fuel to a combustion device, such as an engine.

The fuel tank 10 defines a container volume 18 for receiving a fuel. The container volume 18 is surrounded by a container wall 20. The container wall 20 can include multiple sides. For instance, the container wall can include a top panel, a bottom panel, and four side panels. Alternatively, the fuel tank 10 can have a spherical shape, a cylindrical shape, or any other suitable shape.

In accordance with the present disclosure, the fuel tank 10 is made from a polymer composition containing a polyoxymethylene polymer and an impact modifier comprising a polymer with polycarbonate units. Of particular advantage, the polymer composition is capable of forming a monolayer tank without having to apply any further coatings or layers to the container wall for increasing either impact resistance or permeability resistance.

For instance, polyoxymethylene polymer compositions made in accordance with the present disclosure can have a permeation of less than 5 g mm/m² per day at 40° C. when tested according to SAE Test J2665. SAE Test J2665 tests the permeability of the material with a test fuel comprising 10% ethanol, 45% toluene, and 45% iso-octane. Determination of the steady-state flux reported in gmm/m² per day is carried out per SAE Test J2665, Section 10. In certain embodiments, the polymer composition is capable of producing a polymer material having a permeation of less than 4 g mm/m² per day, such as less than 3 g mm/m² per day, such as less than 2.5 g mm/m² per day, such as less than about 1.5 g mm/m² day. In one embodiment, for instance, the permeation may be from about 0.1 g mm/m² day to about 2.5 g mm/m² day, such as from about 0.1 g mm/m² day to about 1.5 g mm/m² day.

When tested according to a 2 mm wall thickness, such as according to SAE Test J2665, Section 11, the polymer composition of the present disclosure may have a permeation of less than about 3 g/m² per day, such as less than about 2.5 g/m² per day, such as less than 2 g/m² per day, such as even less than 1.5 g/m² per day. When tested with a 3 mm wall thickness, the permeation can also be less than about 2.5 g/m² day, such as less than about 1.5 g/m² day. In one embodiment, for instance, a 3 mm wall thickness may have a permeation of from about 0.05 g/m² day to about 1 g/m² day.

In addition to having excellent permeability properties, as described above, the polymer composition formulated according to the present disclosure also displays excellent impact strength resistance. For instance, the polymer composition may have a Charpy notched impact strength of greater than about 7 kJ/m² when measured at −30° C. according to ISO Test 179/1eA. For instance, the polymer composition may have a Charpy notched impact strength of greater than about 8 kJ/m² when measured at −30° C. In general, the Charpy notched impact strength is less than about 20 kJ/m², such as less than about 15 kJ/m².

The polymer composition can also have good multi axial impact strength. For instance, the polymer composition may have a multi axial impact strength at −30° C. according to ASTM Test D3763 of greater than 4 ftlb-f, such as greater than 10 ftlb-f, such as greater than 15 ftlb-f. The multi axial impact strength is generally less than 60 ftlb-f, such as from about 5 ftlb-f to about 25 ftlb-f.

Since the polyoxymethylene polymer is a thermoplastic polymer, the fuel tank 10 as shown in FIGS. 1 and 2 can be made according to different processes. For instance, in one embodiment, the fuel tank 10 can be formed through a blow molding process. Alternatively, rotational molding or injection molding may be used to produce the tank.

In one particular embodiment, different portions of the fuel tank 10 can be made using injection molding. For instance, as shown in FIGS. 1 and 2, the fuel tank 10 may be formed from a first portion or half 22 and a second portion or half 24. The first portion 22 can then be attached to the second portion 24 using any suitable welding process. Such welding processes include hot-plate welding, vibration welding, laser welding, or ultrasonic welding.

The polymer composition of the present disclosure generally contains a polyoxymethylene polymer that is chemically reacted with or attached to an impact modifier that contains polycarbonate groups. For example, in one embodiment, a coupling agent may be present in the composition that couples the impact modifier to the polyoxymethylene polymer. More particularly, the coupling agent may react with first reactive groups on the polyoxymethylene polymer and with second reactive groups present on the impact modifier. In one embodiment, for instance, the coupling agent may comprise an isocyanate that chemically attaches the impact modifier to the polyoxymethylene polymer.

The impact modifier may comprise a thermoplastic elastomer. In general, any suitable thermoplastic elastomer may be used according to the present disclosure as long as the thermoplastic elastomer can attach to the polyoxymethylene polymer whether through the use of a coupling agent or otherwise and contains at least one carbonate group. In one embodiment, for instance, the thermoplastic elastomer may include reactive groups that directly or indirectly attach to reactive groups contained on the polyoxymethylene polymer. For instance, in one particular embodiment, the thermoplastic elastomer has active hydrogen atoms which allow for covalent bonds to form with the hydroxyl groups on the polyoxymethylene using the coupling agent.

Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are any of the above thermoplastic elastomers as long as the impact modifier contains carbonate groups. The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester dial flexible segments of thermoplastic polyurethane elastomers have hydrogen atoms which can react, for example, with isocyanate groups.

In one particular embodiment, a thermoplastic polyurethane elastomer is used that contains carbonate groups as the impact modifier either alone or in combination with other impact modifiers. The thermoplastic polyurethane elastomer, for instance, may have at least one soft segment of a long-chain diol and/or carbonate groups and a hard segment derived from a diisocyanate and a chain extender. Representative long-chain diols are polyester diols such as poly(butylene adipate)diol, poly(ethylene adipate)diol and poly(ε-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

Thermoplastic elastomers containing carbonate groups can be produced, in one embodiment, using a diol component that contains carbonate groups. For instance, the thermoplastic elastomer can be produced as described above by reacting together a polymer diol containing carbonate groups with an isocyanate and a chain extender. The polymer dial, for instance, may comprise a polycarbonate diol and/or a polyester polycarbonate dial.

A polycarbonate diol may be produced by reacting a diol with a carbonate compound. The carbonate compound may comprise, for instance, a carbonate compound with alkyl groups, a carbonate compound with alkylene groups, or a carbonate compound containing aryl groups. Particular carbonate compounds include dimethyl carbonate, diethyl carbonate, ethylene carbonate, and/or diphenyl carbonate. A polyester polycarbonate, on the other hand, may be formed by reacting a diol with a carbonate compound as described above in the presence of a carboxylic acid.

As described above, the polycarbonate groups contained in the thermoplastic elastomer are generally referred to as soft segments. Thus, the polycarbonate groups have a tendency to lower the hardness of the thermoplastic elastomer. In one embodiment, for instance, the shore A hardness of the thermoplastic elastomer is less than about 98, such as less than about 95, such as less than about 93 when tested according to ISO Test 868. The shore A hardness of the material is generally greater than about 80, such as greater than about 85.

The amount of impact modifier contained in the polymer composition used to form articles, such as containment devices, can vary depending on many factors. The amount of impact modifier present in the composition may depend, for instance, on the desired permeability of the resulting material and/or on the amount of coupling agent present and/or on the type of polyoxymethylene polymer present. In general, one or more impact modifiers may be present in the composition in an amount greater than about 5% by weight, such as in an amount greater than about 10% by weight. The impact modifier is generally present in an amount less than 30% by weight, such as in an amount less than about 25% by weight. Of particular advantage, the impact modifier of the present disclosure may be present in relatively great amounts while still preserving the permeability properties of the material. For example, the impact modifier may be present in the composition in an amount greater than about 17% by weight, such as in an amount greater than about 20% by weight, while still having the desired permeability properties. For example, in one embodiment, the impact modifier may be present in an amount from about 20% to about 25% by weight while still producing a composition that has a permeation of less than 3 g/m² day when tested at a thickness of 2 mm and at 40° C.

The polyoxymethylene polymer used in the polymer composition may comprise a homopolymer or a copolymer. The polyoxymethylene polymer, however, generally contains a relatively high amount of reactive groups, such as hydroxyl groups in the terminal positions. More particularly, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 50 mmol/kg.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In addition to having a relatively high terminal hydroxyl group content, the polyoxymethylene polymer according to the present disclosure also has a relatively low amount of low molecular weight constituents. As used herein, low molecular weight constituents (or fractions) refer to constituents having molecular weights below 10,000 dalton. In order to produce a polymer having the desired permeability requirements, the present inventors unexpectedly discovered that reducing the proportion of low molecular weight constituents can dramatically improve the permeability properties of the resulting material, when attached to an impact modifier. In this regard, the polyoxymethylene polymer contains low molecular weight constituents in an amount less than about 10% by weight, based on the total weight of the polyoxymethylene. In certain embodiments, for instance, the polyoxymethylene polymer may contain low molecular weight constituents in an amount less than about 5% by weight, such as in an amount less than about 3% by weight, such as even in an amount less than about 2% by weight.

The preparation of the polyoxymethylene can be carried out by polymerization of polyoxymethylene-forming monomers, such as trioxane or a mixture of trioxane and dioxolane, in the presence of ethylene glycol as a molecular weight regulator. The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted. The above-described procedure for the polymerization can lead to polymers having comparatively small proportions of low molecular weight constituents. If a further reduction in the content of low molecular weight constituents were to be desired, this can be effected by separating off the low molecular weight fractions of the polymer after the deactivation and the degradation of the unstable fractions after treatment with a basic protic solvent. This may be a fractional precipitation from a solution of the stabilized polymer; polymer fractions of different molecular weight distribution being obtained.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2% by weight.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

Hₓ[MₘM′ₙO_{z}]yH₂O

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphonnolybdotungstovanadic acid, phosphotungstovanadic acid, silicotungstic acid, silicomolybdic acid, silicomolybdotungstic acid, silicomolybdotungstovanadic acid and acid salts thereof.

Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfils the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)ₙ—(COOR′)

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)ₘ—CH—(COOR′)₂

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, dimethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 weight percent, preferably in an amount ranging from 0.01 to 5 weight percent, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain as a rule at least 80%, such as at least 90%, oxymethylene units. Such conventional polyoxymethylenes may be present in the composition as long as the resulting mixture maintains the above amounts of hydroxyl terminated groups and the above amounts of low molecular weight constituents.

The polyoxymethylene polymer present in the composition can generally have a melt volume rate (MVR) of less than 50 cm³/10 min, such as from about 1 to about 40 cm³/10 min, determined according to ISO 1133 at 190° C. and 2.16 kg.

The amount of polyoxymethylene polymer present in the polymer composition of the present disclosure can vary depending upon the particular application. In one embodiment, for instance, the composition contains polyoxymethylene polymer in an amount of at least 50% by weight, such as in an amount greater than about 60% by weight, such as in an amount greater than about 65% by weight, such as in an amount greater than about 70% by weight. In general, the polyoxymethylene polymer is present in an amount less than about 95% by weight, such as in an amount less than about 90% by weight, such as in an amount less than about 85% by weight.

The coupling agent present in the polymer composition comprises a coupling agent capable of coupling the impact modifier to the polyoxymethylene polymer. In order to form bridging groups between the polyoxymethylene polymer and the impact modifier, a wide range of polyfunctional, such as trifunctional or bifunctional coupling agents, may be used. The coupling agent may be capable of forming covalent bonds with the terminal hydroxyl groups on the polyoxymethylene polymer and with active hydrogen atoms on the impact modifier. In this manner, the impact modifier becomes coupled to the polyoxymethylene through covalent bonds.

In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 1% by weight, such as in an amount greater than 2% by weight. In one particular embodiment, the coupling agent is present in an amount from about 0.2% to about 5% by weight. To ensure that the impact modifier has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

In one embodiment, a formaldehyde scavenger may also be included in the composition. The formaldehyde scavenger, for instance, may be amine-based and may be present in an amount less than about 1% by weight.

The polymer composition of the present disclosure can optionally contain a stabilizer and/or various other known additives. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding, such as dyes and/or pigments.

In general, other additives can be present in the polymer composition in an amount up to about 10% by weight, such as from about 0.1% to about 5% by weight, such as from about 0.1 to about 2% by weight.

When forming containment devices in accordance with the present disclosure, the above described components can be melt blended together, which automatically causes the reaction to occur between the coupling agent, the polyoxymethylene polymer, and the impact modifier. As described above, the coupling agent reacts with the reactive end groups on the polyoxymethylene polymer and the reactive groups on the impact modifier. The reaction between the components can occur simultaneously or in sequential steps. In one particular embodiment, the components in the composition are mixed together and then melt blended in an extruder.

The reaction of the components is typically effected at temperatures of from 100 to 240° C., such as from 150 to 220° C., and the duration of mixing is typically from 0.5 to 60 minutes.

The proportion of coupling agent in relation to the other components can be chosen within wide limits. For instance, the coupling agent may be used in an amount such that there are from 0.2 to 5 mol, preferably from 0.5 to 4 mol, of the coupling agent per mole of active hydrogen atoms, for example in the form of hydroxyl groups, of the polyoxymethylene containing active hydrogen atoms.

In one embodiment, the molding composition of the present disclosure is reacted together and compounded prior to being used in a molding process. For instance, in one embodiment, the different components can be melted and mixed together in a conventional single or twin screw extruder at a temperature described above. Extruded strands may be produced by the extruder which are then pelletized. Prior to compounding, the polymer components may be dried to a moisture content of about 0.05 weight percent or less. If desired, the pelletized compound can be ground to any suitable particle size, such as in the range of from about 100 microns to about 500 microns.

As described above, the formation of VOC and compressed gas containment devices in accordance with the present disclosure can be done using any suitable molding process, such as blow molding, rotational molding, or injection molding. In one particular embodiment, injection molding is used to form the containment devices. For instance, a plurality of portions of the containment devices can be first produced and then welded together.

When injection molding, the pre-compounded composition or the individual components can be fed to a heated barrel, mixed and forced into a mold cavity. The heated barrel may comprise a single screw extruder or a twin screw extruder. While in the barrel, the composition is heated to a temperature sufficient to form a molten mixture that flows. Once forced into a mold cavity, the polymer composition cools and hardens producing the desired part. In one embodiment, injection molding can be gas assisted. For instance, non-reactive gases, such as nitrogen or supercritical gases can be used to place pressure on the molten material for forcing the material against the walls of the mold. In other embodiments, however, no such gas is needed to obtain the pressures necessary during injection into the mold.

After the portions or parts of the containment device are molded, the different portions are then attached together. In one embodiment, for instance, any suitable welding process may be used to attach the portions together. For example, the portions may be attached together using laser welding, ultrasonic welding, linear vibration, orbital vibration, hot plate welding, or spin welding. During laser welding, the components are subjected to electromagnetic radiation at wavelengths that causes absorption. The absorption of the electromagnetic radiation results in heating and melting at the interface of the components causing the different parts to join together.

During linear vibration, heat is generated by moving one part against another under pressure through a linear displacement in the plane of the joint. When a molten state is reached at the joint interface, vibration is stopped and clamping pressure is maintained until a bond is formed between the parts. Orbital vibration is similar to linear vibration only an electromagnetic drive is used to create relative motion between the two thermoplastic portions. This constant velocity motion generates heat and causes the two parts to bond together.

During hot plate welding, a heated platen assembly is introduced between the two portions to be joined together. Once the interface polymer on each part is melted or softened, the heated platen is withdrawn and the parts are clamped together.

Spin welding is a process that joins circular thermoplastic parts by bringing the part interfaces together under pressure with a circular spinning motion. One of the portions is typically held stationary in a fixture while the other is rotated against it under pressure. The frictional heat that is generated causes the part interfaces to melt and fuse together.

In one particular embodiment, the different parts or portions of the containment device are bonded together using ultrasonic welding. During ultrasonic welding, an ultrasonic tool called a horn transfers vibratory energy through one or both parts at the interface. The vibratory energy is converted into heat through friction which causes the parts to bond together when pressure is applied. More particularly, during ultrasonic welding, one or more of the parts can be held between an anvil and the horn, which is connected to a transducer. Typically, a low-amplitude acoustic vibration is emitted. The frequency used during ultrasonic welding can generally be from about 10 kHz to about 100 kHz.

As described above, in an alternative embodiment, articles of the present disclosure may be produced through blow molding. In general, the blow molding process begins with melting the molding composition and forming it into a parison. Single screw extruders with the appropriate screw design are used to convert the composition (usually pellets) into a homogeneous melt. Depending on the melt strength one can use the composition with the regular classic extrusion blow molding process. This applies for the composition with a max. parison length of 250 to 300 mm. For larger parison length it might be necessary to use the extrusion blow molding process with an additional accumulator head. The size of the head depends on the amount of material to form a specific container size and wall thickness.

The basic process has two fundamental phases. Initially, the parison itself (parison means tube-like piece of plastic) is extruded vertically out of the die. Once the parison settles on the injector pin (air injector), the mold is closed. In the second phase air is injected into the tube and blown up till it reaches the wall of the tool.

The pressure is generally held until the melt solidifies. Another key factor for this process is to achieve components with a homogenous wall thickness distribution throughout the whole component/parison length. This may be achieved with a wall thickness control feature (WDS) at the die head. In general, this feature may comprise a programming step to establish an extrusion/wall thickness profile while the parison is ejected from the accumulator head.

The present disclosure may be better understood with reference to the following example.

### Example

The following experiments were conducted in order to show some of the benefits and advantages of compositions made according to the present disclosure.

First, polyoxymethylene polymers were prepared using cationic polymerization with ethylene glycol as the chain terminating agent, followed by solution hydrolysis. One of the polyoxymethylene polymers (Sample No. 1) was made using a conventional catalyst, namely boron trifluoride. Sample No. 2 and Sample No. 3 below, however, were formulated using a polyoxymethylene polymer that was produced using a heteropoly acid and thus contained low amounts of low molecular weight constituents.

The polyoxymethylene polymers were then melt blended with an impact modifier, a coupling agent, and a stabilizer package including an antioxidant and a lubricant.

The lubricant used contained a combination of ethylene bis stearamide and ethylene bis palmitamide. The antioxidant used was tetrakis-(methylene-(3,5-di-(tert)-butyl-4-hydrocinnamate))methane. The formulated compositions were melt blended using a 32 mm twin screw extruder. The extrusion conditions were as follows:

TABLE 1

| Extruder Temperatures ° C. | | | | | | | | | | Extruder | Extruder |
|---|---|---|---|---|---|---|---|---|---|---|---|
| Barrel Zone Number | | | | | | | | | | Feed Rate | Screw Speed |
| 1 | 2 | 3 | 4 | 5 | 6 | 7 | 8 | 9 | DIE | (kg/hr) | (rpm) |
| 190 | 190 | 190 | 185 | 175 | 175 | 165 | 165 | 165 | 175 | 30 | 225 |

For Sample No. 1 and Sample No. 2, the impact modifier used was a thermoplastic polyurethane elastomer obtained from BASF under the trade name ELASTOLLAN. The impact modifier used in Sample No. 3, on the other hand, comprised a thermoplastic polyurethane elastomer that contained polycarbonate units. The thermoplastic elastomer containing the polycarbonate units was obtained from Bayer. The coupling agent used was 4,4′-diphenylmethane diisocyanate. As described above, the compositions also contained a stabilizer package including an antioxidant and a lubricant.

In Sample Nos. 1 through 3, the stabilizer package was present in an amount of 0.4% by weight and the impact modifier was present in an amount of 18% by weight. The coupling agent was added to Sample No. 1 and Sample No. 3 in an amount of 0.5% by weight and was added to Sample No. 2 in an amount of 0.8% by weight.

The samples were molded for testing using a Roboshot 165 SiB molding machine. The test specimen was a 4″ diameter disc 1/16″ of an inch thick. The molding conditions are included in the following table.

TABLE 2

| | |
|---|---|
| Barrel Zone 1 (° C.) | 177 |
| Barrel Zone 2 (° C.) | 182 |
| Barrel Zone 3 (° C.) | 188 |
| Nozzle (° C.) | 193 |
| Melt (° C.) | 205 |
| Mold Movable (° C.) | 80 |
| Mold Stationary (° C.) | 80 |
| Back Pressure (psi) | 50 |
| Hold Pressure (psi) | 11600 |
| Hold Pressure (psi) | 35 |
| Cooling Time (sec) | 15 |
| Cycle Time (sec) | 50 |
| Melt Cushion (mm) | 5 |
| Injection Velocity (mm/s) | 200 |
| Injection Time (sec) | 2 |
| Screw Retraction Time (sec) | 10 |

Material sample plaques were made by injection molding four inch diameter discs with an average thickness between 1/32 and ⅛ of an inch. The plaques were die cut into three inch circles in order to fit the permeation cup. The thickness of the material was measured at a minimum of five points, and the average thickness was determined from these measurements. Permeation cup test fixtures were assembled with the desired material plaque per SAE J2665, Sections 8.3 through 8.11.

Permeation values of the material were determined gravimetrically using a modified version of SAE J2665 “Cup Weight Loss Method” (Issued October 2006). Vapometer Model 68 permeation cups, commercially available from Thwing-Albert, were used as the test fixture. The cups were modified per SAE J2665 in the following manner: 1) Neoprene gaskets were replaced with FKM gaskets and 2) the six supplied knurled head screws were replaced to allow for torque wrench tightening.

Fuel CE10 was used as the test fuel (10% ethanol, 45% toluene, and 45% iso-octane). The cups were placed right-side up into a controlled thermal environment (T=40° C.±2° C.) so that the test material was in contact with only the vapor phase of the fuel. The weight of the test fixtures were measured twice a week. Weight-loss versus time was plotted using the method described in SAE J2665, Section 9. Determination of the steady-state flux, reported as [grams/(m²-day)], was carried out per SAE J2665, Section 10. Determination of the vapor transmission rate (VTR), or “permeation constant,” reported as [grams-mm/(m²-day)], was carried out per SAE J2665, Section 11.

The permeation results for Sample Nos. 1 through 3 are as follows:

TABLE 3

| | | Impact Modifier | | % Reduction | % Reduction |
|---|---|---|---|---|---|
| Sample | Impact Modifier | Concentration in the | Permeation | vs. Sample | vs. Sample |
| No. | Type | POM/TPE Blend (wt %) | (g mm/m² day) | No. 1 | No. 2 |
| 1 | Thermoplastic | 18 | 8.5 | N/A | N/A |
| | Polyurethane | | | | |
| | Elastomer | | | | |
| 2 | Thermoplastic | 18 | 5.7 | 32.9 | N/A |
| | Polyurethane | | | | |
| | Elastomer | | | | |
| 3 | Thermoplastic | 18 | 3.5 | 58.8 | 38.6 |
| | Polyurethane | | | | |
| | Elastomer | | | | |
| | Containing | | | | |
| | Polycarbonate | | | | |
| | Groups | | | | |

Sample No. 2 and Sample No. 3 above were then tested for various physical properties. The results are shown below:

TABLE 4

| | | | Sample | Sample |
|---|---|---|---|---|
| Tests | Test Method | Units | No. 3 | No. 2 |
| Tensile Modulus | ISO 527 | MPa | 1699 | 1795 |
| Tensile Strength at yield | ISO 527 | MPa | 44.4 | 47.6 |
| Tensile Elongation at yield | ISO 527 | % | 13.8 | 11.8 |
| Tensile Elongation at break | ISO 527 | % | 73.6 | 40.7 |
| Charpy notched impact at 23° C. | ISO 179/1eA | kJ/m² | 19.8 | 17.4 |
| Charpy notched impact at | ISO 179/1eA | kJ/m² | 8.2 | 10.5 |
| −30° C. | | | | |
| Penetration-Test 2 mm at 23° C. | ISO 6603-2 | J | 41.1 | 43.3 |
| Ep (Energy to 50% force) | | | | |

Various polymer compositions similar to Sample No. 2 above were then formulated. In the compositions, the amount of the thermoplastic polyurethane elastomer was varied. Two formulations (Sample No. 2A and Sample No. 2B) contained the impact modifier in amounts less than 18% by weight. Two other formulations (Sample No. 2C and Sample No. 2D) contained the impact modifier in amounts greater than 18% by weight. The following polymer compositions were formulated and tested for permeation.

TABLE 5

| | LMWF | Standard | Coupling | |
|---|---|---|---|---|
| Sample | POM Flake | Impact Modifier | Agent | Stabilizer |
| No. | (Wt. %) | (Wt. %) | (Wt. %) | (Wt. %) |
| 2A | 90.7 | 9.0 | 0.0 | 0.4 |
| 2B | 85.2 | 14.0 | 0.5 | 0.4 |
| 2 | 80.9 | 18.0 | 0.8 | 0.4 |
| 2C | 68.7 | 30.0 | 1.0 | 0.4 |
| 2D | 61.7 | 38.0 | 0.0 | 0.4 |

The permeation results for the above samples are shown in the table below. Also in the table are calculated permeation values for purposes of comparison.

TABLE 6

| Impact Modifier | Permeation | | Permeation (g/m² day) | |
|---|---|---|---|---|
| Concentration | (g mm/m²/day) | | for 2 mm wall thickness | |
| (wt %) | Sample B | Sample C | Sample B | Sample C |
| 9 | 2.6 | 1.6* | 1.3 | 0.8* |
| 14 | 4.6 | 2.8* | 2.3 | 1.4* |
| 16 | 4.9* | 3.0* | 2.4* | 1.5* |
| 18 | 5.7 | 3.5 | 2.9 | 1.8 |
| 22 | 8.1* | 4.9* | 4.0* | 2.5* |
| 30 | 27.3 | 16.7* | 13.6 | 8.4* |
| 38 | 27.5 | 16.9* | 13.8 | 8.5* |

*Calculated values as opposed to measured values

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A containment device comprising:
a container defining a volume surrounded by a wall, the container including an opening in fluid communication with the volume;
and wherein the wall is made from a polymer composition comprising:
a) a polyoxymethylene polymer in which at least 50% of the terminal groups are hydroxyl groups, the polyoxymethylene polymer also containing low molecular weight constituents having molecular weights below 10,000 dalton in an amount less than about 10% by weight, based on the total mass of polyoxymethylene polymer;
b) an impact modifier comprising a thermoplastic elastomer, the impact modifier being chemically attached to the polyoxymethylene polymer, the thermoplastic elastomer containing polycarbonate units;
and wherein the polymer composition has a permeation of less than 5 g mm/m² per day at 40° C. according to SAE Test J2665.

2. A containment device as defined in claim 1, wherein the thermoplastic elastomer comprises a thermoplastic polyurethane elastomer containing the polycarbonate units.

3. A containment device as defined in claim 1, wherein the impact modifier is present in the polymer composition in an amount of from about 5% to about 30% by weight.

4. A containment device as defined in claim 1, wherein the impact modifier is present in the polymer composition in an amount of from about 17% to about 25% by weight, and wherein the polymer composition has a permeation of less than 3 g/m² day when tested at a thickness of 2 mm at 40° C.

5. A containment device as defined in claim 1, wherein the impact modifier has a Shore A hardness of from about 85 to about 95 according to ISO Test 868.

6. A containment device as defined in claim 1, wherein the polymer composition further comprises a coupling agent, the coupling agent coupling the polyoxymethylene polymer and the thermoplastic elastomer together.

7. A containment device as defined in claim 6, wherein the coupling agent comprises an isocyanate.

8. A containment device as defined in claim 1, wherein the polymer composition has a permeation of less than about 2.5 g/m² day when tested at a thickness of 2 mm at 40° C.

9. A containment device as defined in claim 1, wherein the containment device comprises a fuel tank that has a volumetric capacity of up to 10 gallons.

10. A containment device as defined in claim 1, wherein the wall of the containment device comprises only a monolayer of the polymer composition.

11. A containment device as defined in claim 1, wherein the wall has a thickness of from about 0.5 mm to about 10 mm.

12. A containment device as defined in claim 1, wherein the containment device includes a first portion welded to a second portion, the first and second portions having been formed by injection molding the polymer composition.

13. A containment device as defined in claim 1, wherein the containment device comprises a blow molded container.

14. A containment device as defined in claim 1, wherein the polymer composition further comprises a heteropoly acid.

15. A containment device as defined in claim 6, wherein the coupling agent comprises methylenediphenyl 4,4′-diisocyanate, the methylenediphenyl 4,4′-diisocyanate being present in the polymer composition in an amount from about 0.5% to about 3% by weight.

16. A containment device as defined in claim 7, wherein the thermoplastic elastomer comprises a thermoplastic polyurethane elastomer, the thermoplastic polyurethane elastomer being present in the polymer composition in an amount from about 15% to about 30% by weight, and wherein at least 70% of the terminal groups of the polyoxymethylene polymer are hydroxyl groups, the polyoxymethylene polymer being present in the polymer composition in an amount of at least about 70% by weight, the polyoxymethylene polymer containing the low molecular weight constituents in an amount less than about 5% by weight based upon the total mass of the polyoxymethylene polymer, the wall of the containment device comprising only a monolayer of the polymer composition, the wall having a thickness of from about 1.5 mm to about 4 mm.

17. A containment device as defined in claim 16, wherein the containment device comprises a fuel tank.

18. A containment device as defined in claim 1, wherein the polymer composition has a Charpy notched impact strength of greater than about 7 kJ/m² when measured at −30° C. according to ISO Test 179/1eA.

19. A containment device as defined in claim 16, wherein the polymer composition has a Charpy notched impact strength of greater than about 7 kJ/m² when measured at −30° C. according to ISO Test 179/1eA.

20. An engine incorporating a fuel tank, the fuel tank comprising a containment device as defined in claim 1.

21. A containment device as defined in claim 6, wherein the polyoxymethylene polymer includes first reactive groups and the impact modifier includes second reactive groups, the coupling agent causing covalent bonding to occur between the first reactive groups on the polyoxymethylene polymer and the second reactive groups on the impact modifier.

22. A process for producing the containment device defined in claim 1, the process comprising:
injection molding the polymer composition into a first mold to form a first portion of the containment device;
injection molding the polymer composition into a second mold to form a second portion of the containment device; and
welding the first portion to the second portion to form the containment device.

23. A process for producing the containment device defined in claim 1, the process comprising:
blow molding the polymer composition to form the container.
